(19) United States
(12) Patent Application Publication
(10) Pub. No.: US 2026/0343553 A1
(43) Pub. Date: Oct. 29, 2026

(54) THREE-PORT UPLINK TRANSMISSION

(71) Applicant: ZTE Corporation, Shenzhen (CN)

(72) Inventors: Ke YAO, Shenzhen (CN); Bo GAO, Shenzhen (CN); Yang ZHANG, Shenzhen (CN); Guangyu JIANG, Shenzhen (CN)

(21) Appl. No.: 19/703,005

(22) Filed: Jun. 9, 2026

Related U.S. Application Data
(63) Continuation of application No. PCT/CN2023/139306, filed on Dec. 15, 2023.

(51) Int. Cl. H04W 72/21; H04B 7/0456

(52) U.S. Cl. CPC H04W 72/21; H04B 7/0456

(57) ABSTRACT

Some embodiments of the present disclosure are related to three-port uplink transmission. An example wireless communication method includes of wireless communication, including: receiving, by a wireless device from a network device, configuration information and uplink grant information for a PUSCH transmission, in which the configuration information indicates a codebook to be used with the three-port uplink transmission; determining, by the wireless device, a precoder from a three-port codebook for a PUSCH transmission based on the configuration information and the uplink grant information; and transmitting, from the wireless device to the network device, the PUSCH transmission according to the precoder.

### CROSS-REFERENCE TO RELATED APPLICATION(S)

This application is a continuation of International Patent Application No. PCT/CN2023/139306, filed on Dec. 15, 2023. The entire contents of the before-mentioned patent application is incorporated by reference as part of the disclosure of this application.

### TECHNICAL FIELD

This disclosure is directed generally to digital wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs. Various techniques, including new ways to provide higher quality of service, longer battery life, and improved performance are being discussed.

### SUMMARY

Techniques are disclosed for configuring SRS transmission to support three-port uplink transmission. Herein, a Tx may correspond to a port; a Tx or port is used interchangeable with a Tx port, an antenna port, a transmit antenna, or a transmit antenna port.

In one aspect, a method of wireless communication performed by a wireless device is disclosed. The method includes receiving, by the wireless device from a network device, configuration information and uplink grant information for a PUSCH transmission; determining, by the wireless device, a precoder from a 3-port codebook for a PUSCH transmission based on the configuration information and the uplink grant information; and transmitting, from the wireless device to the network device, the PUSCH transmission according to the precoder.

In another aspect, a method of wireless communication performed by a network device is disclosed. The method includes transmitting, by the network device to a wireless device, configuration information and uplink grant information for a PUSCH transmission; in which the configuration information and the uplink grant information are used to determine a precoder for a PUSCH transmission by the wireless device; and receiving, from the wireless device at the network device, the PUSCH transmission according to the precoder.

In yet another exemplary aspect, the above-described methods are embodied in the form of processor-executable code and stored in one or more non-transitory computer-readable storage media. The code included in the computer readable storage media when executed by one or more processors, causes the one or more processors to implement the methods described in this patent document.

In yet another exemplary embodiment, a wireless communication device that is configured or operable to perform the above-described methods is disclosed. The wireless communication device may be a wireless device (e.g., a user equipment (UE)), or a network device (e.g., a base station (BS)).

The above and other aspects and their implementations are described in greater detail in the drawings, the descriptions, and the claims.

### BRIEF DESCRIPTION OF THE DRAWING

FIG. 1 shows an example of a wireless communication system in accordance with some embodiments of the disclosed technology.

FIG. 2 is a block diagram representation of a portion of an apparatus in accordance with some embodiments of the disclosed technology.

FIG. 3 is a diagram illustrating example antenna layouts for 3Tx UE in accordance with some embodiments of the disclosed technology.

FIG. 4 is a flowchart of an example method of wireless communication.

FIG. 5 is a flowchart of an example method of wireless communication.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

The new radio (NR) technology of fifth generation (5G) mobile communication systems is continuously improved to provide higher quality wireless communication. Multiple Input Multiple Output (MIMO) is one of key features in 5G NR. Legacy technique for MIMO has already supported 2, 4, and 8 transmit (Tx) ports for UL transmission.

Generally, if more than one transmit antenna (1Tx) is equipped for a user equipment (UE), 2 Tx, 4Tx, or 8Tx UE is considered, and so a codebook for physical uplink shared channel (PUSCH) is specified as 2 ports, 4 ports, or 8 ports for such requirements. However, in reality, UE is commonly equipped with 1Tx or 2Tx, and 4Tx UE is rare due to cost and/or complexity. As a compromise, 3Tx is considered for UE configuration as a next step of 2Tx UE. To support 3Tx UE, 3Tx UL transmission schemes need be designed, e.g., 3Tx (port) PUSCH transmission, and/or 3Tx (port) sounding reference signals (SRS).

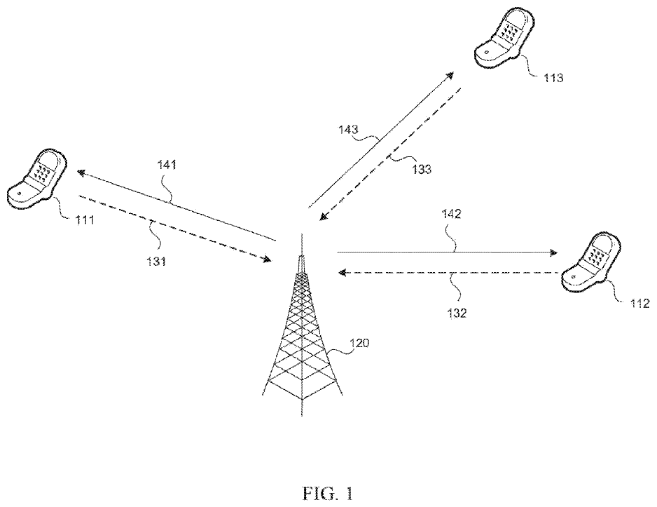

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include downlink control information (DCI) or high layer signaling or downlink information. The UE may be, for example, a smartphone, a tablet, a mobile computer, a machine to machine (M2M) device, a terminal, a mobile device, an Internet of Things (IoT) device, and so on.

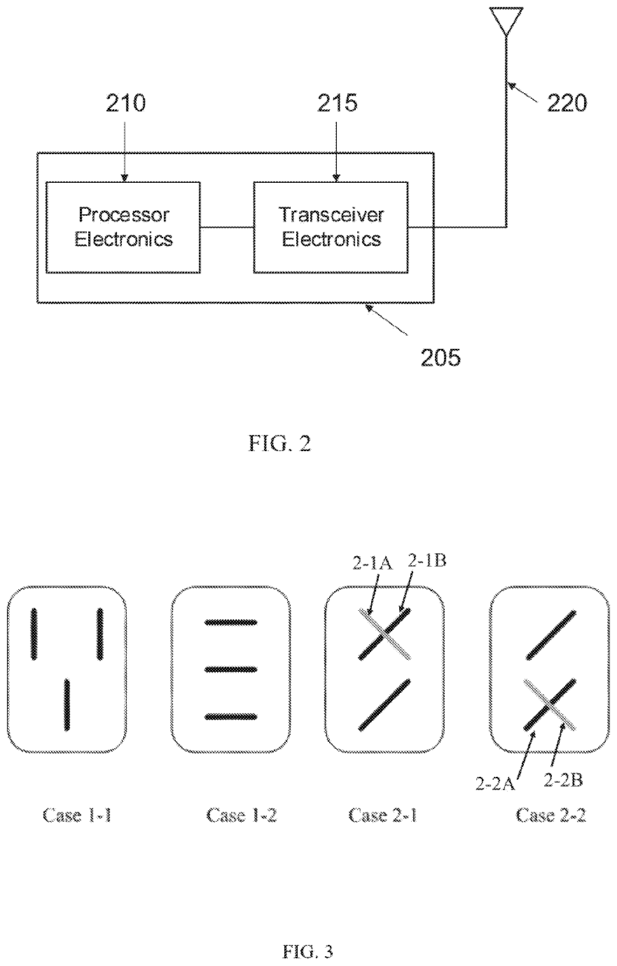

FIG. 2 is a block diagram representation of a portion of an apparatus based on some embodiments of the disclosed technology. An apparatus 205, such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

SRS in wireless communication is used in multiple aspects for efficient network performance, especially in LTE (Long-Term Evolution) and 5G networks. Channel sounding may involve sending a known signal from a transmitter (e.g., a UE), which is then analyzed at the receiver (e.g., a BS) to gain information about the wireless channel. This process may help in understanding various characteristics of the communication channel, such as path loss, fading, delay spread, Doppler spread, etc. SRS may enable the network to adaptively optimize data transmission for efficiency, speed, and reliability.

For codebook based uplink transmissions, a set of candidate precoders (i.e., precoding matrices) for PUSCH transmissions may collectively be referred to as a codebook. The candidate precoders can be determined based on, e.g., candidate codebook types (e.g., non-coherent, partial-coherent, full-coherent), and may be stable. On the other hand, a precoder used for a given PUSCH transmission may be indicated by a transmit precoding matrix indicator (TPMI) which is a dynamically indicated. The network may need to indicate one precoder from the codebook based on one or more factors including, e.g., the channel sounding by SRS. Merely by way of example, to perform an uplink transmission, a user equipment (UE) transmits SRS to a base station. Upon receiving the SRS, the base station may perform channel estimation. This process involves analyzing the SRS to understand the channel conditions, such as path loss, fading, and interference patterns. The channel estimation may give the base station a detailed understanding of how a signal propagates from the UE to the base station over the uplink channel. UE may report capability information (including, e.g., a codebook type) to the base station. Based on the channel estimation and/or UE capability information reported by the UE, the base station may determine configuration information and uplink grant information for the UE. For a codebook based uplink transmission, the configuration information and/or the uplink grant information may include, e.g., a codebook type, an SRS resource indicator (SRI), the precoding information, the number of layers, antenna port(s), uplink power control information, or the like, or a combination thereof. According to the configuration information and the uplink grant information, the UE may identify, from a codebook, a precoder (also referred to as a precoding matrix) according to which an uplink transmission (e.g., a PUSCH transmission) is performed. For a multi-port uplink transmission via multiple antenna ports of the UE, a full transmission power may be shared by the non-zero power (NZP) port(s) involved in the transmission.

The candidate precoders can be determined based on configuration info, thus stable, but the precoder used for a given PUSCH transmission is indicated by a TPMI which is a dynamically indicated.

FIG. 3 is a diagram illustrating example antenna layouts for 3Tx UE in accordance with some embodiments of the disclosed technology. Case 1-1 and case 1-2 illustrate non-coherent layouts. Case 2-1 and case 2-2 illustrate partial coherent layouts. In a non-coherent three-port layout, the three antenna ports are not coherent with each other. In a partial coherent three-port layout, two antenna ports, including ports 2-1A and 2-1B in case 1 and ports 2-2A and 2-2B in case 2, can be coherent, but neither one of the two coherent antenna ports is coherent with the third antenna port.

It is understood that the illustration of two antenna ports as being parallel or in a cross arrangement do not necessarily suggest that the two antenna ports are coherent or non-coherent. For example, as illustrated in each of case 2-1 and 2-2 in FIG. 3, the two coherent ports are shown as a cross polarized antenna pair. It is understood that the cross arrangements are for illustration purposes and not intended to be limiting. Coherent antenna ports can be arranged in parallel. As another example, the three non-coherent antenna ports are illustrated as being parallel to each other in case 1-2; the three antenna ports can also be fully coherent, in which all the three antenna ports are coherent with each other.

In addressing the specific needs to support a three-port PUSCH transmission, a codebook tailored to the ports, as well as the power control and/or full power transmission may be designed. Details are provided as follows.

### Embodiment 1: Three-Port Codebook

A codebook for a 3Tx (also referred as three-port) uplink transmission may be designed on a case-by-case basis based on parameters including, e.g., coherency information of the ports, configured transmit power, the power amplifier rating of each port, or the like, or a combination thereof. A codebook for a three-port uplink transmission via non-coherent and partial-coherent ports can be determined as described below. Coefficients of elements of the matrix can be determined as one of the followings:
normalized coefficient:

$$\frac{1}{\sqrt{M}} ,$$

where M is number of non-zero power (NZP) elements in the precoding matrix.
with ⅓ full power power amplifier (PA) per port: each port has the power capability of at most ⅓ of the full power (i.e., maximum transmit power, or Pcmax), then evenly split among NZP elements (i.e., among MIMO layers) in each port, i.e.,

$$\frac{1}{\sqrt{{N}_{port} * {N}_{p}}} ,$$

where Nₚ is the number (or count) of NZP elements for port p, and Nₚₒᵣₜ is number of ports in the precoding matrix, e.g., 3.
✓ elements in different ports with different number of layers may have different coefficients, e.g.,

$$\frac{1}{\sqrt{{N}_{port} * {N}_{p}}}$$

is calculated for each port, or
✓ elements in different ports with different number of layers have same coefficient, e.g., can be determined according to

$$\frac{1}{\sqrt{{N}_{port} * {max}_{p} {N}_{p}}} ,$$

as shown in Table 1, where

$${max}_{p} {N}_{p}$$

refers to the maximum number (or count) of NZP elements among various ports p.
with ½ full power PA per port: if the number (or count) of NZP ports <3, i.e., 1, or 2, Nₚₒᵣₜ can be assumed as 2 using the above rules for ⅓ full power PA per port, as shown in Table 1.

TABLE 1

| | Non-coherent | Partial-coherent |
|---|---|---|
| Rank 1 | Normalized coefficient: | For first case, e.g., case 2-1 |
| | $[ \begin{matrix}1 \\ 0 \\ 0\end{matrix} ] , [ \begin{matrix}0 \\ 1 \\ 0\end{matrix} ] , [ \begin{matrix}0 \\ 0 \\ 1\end{matrix} ]$ | |
| | With 1/3 full power PA per port: | Normalized coefficient: |
| | $\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ]$ | $\frac{1}{\sqrt{2}} [ \begin{matrix}1 \\ 1 \\ 0\end{matrix} ] , \frac{1}{\sqrt{2}} [ \begin{matrix}1 \\ - 1 \\ 0\end{matrix} ] , \frac{1}{\sqrt{2}} [ \begin{matrix}1 \\ j \\ 0\end{matrix} ] , \frac{1}{\sqrt{2}} [ \begin{matrix}1 \\ - j \\ 0\end{matrix} ]$ |
| | With 1/2 full power PA per port: | With 1/3 full power PA per port: |
| | $\frac{1}{\sqrt{2}} [ \begin{matrix}1 \\ 0 \\ 0\end{matrix} ] , \frac{1}{\sqrt{2}} [ \begin{matrix}0 \\ 1 \\ 0\end{matrix} ] , \frac{1}{\sqrt{2}} [ \begin{matrix}0 \\ 0 \\ 1\end{matrix} ]$ | $\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ - j \\ 0\end{matrix} ]$ |
| | | With 1/2 full power PA per port: |
| | | $\frac{1}{\sqrt{2}} [ \begin{matrix}1 \\ 1 \\ 0\end{matrix} ] , \frac{1}{\sqrt{2}} [ \begin{matrix}1 \\ - 1 \\ 0\end{matrix} ] , \frac{1}{\sqrt{2}} [ \begin{matrix}1 \\ j \\ 0\end{matrix} ] , \frac{1}{\sqrt{2}} [ \begin{matrix}1 \\ - j \\ 0\end{matrix} ]$ |
| | | . . . |
| | | For second case, another coherent ports |
| | | index may be adopted, e.g., case 2-2: |
| | | $\frac{1}{\sqrt{2}} [ \begin{matrix}0 \\ 0 \\ 1\end{matrix} ] , \frac{1}{\sqrt{2}} [ \begin{matrix}0 \\ 1 \\ - 1\end{matrix} ] , \frac{1}{\sqrt{2}} [ \begin{matrix}0 \\ 1 \\ j\end{matrix} ] , \frac{1}{\sqrt{2}} [ \begin{matrix}0 \\ 1 \\ - j\end{matrix} ]$ |
| | | For third case, another coherent ports |
| | | index may be adopted, e.g., case 2-2: |
| | | $\frac{1}{\sqrt{2}} [ \begin{matrix}1 \\ 0 \\ 1\end{matrix} ] , \frac{1}{\sqrt{2}} [ \begin{matrix}1 \\ 0 \\ - 1\end{matrix} ] , \frac{1}{\sqrt{2}} [ \begin{matrix}1 \\ 0 \\ j\end{matrix} ] , \frac{1}{\sqrt{2}} [ \begin{matrix}1 \\ 0 \\ - j\end{matrix} ]$ |
| | | Note: the coherent ports indexing may |
| | | be different from the first case, here |
| | | taking normalized coefficient as |
| | | example. |
| Rank 2 | Normalized coefficient: | For first case, e.g., case 2-1: |
| | $\frac{1}{\sqrt{2}} [ \begin{matrix}1 & 0 \\ 0 & 1 \\ 0 & 0\end{matrix} ] , \frac{1}{\sqrt{2}} [ \begin{matrix}1 & 0 \\ 0 & 0 \\ 0 & 1\end{matrix} ] , \frac{1}{\sqrt{2}} [ \begin{matrix}0 & 0 \\ 1 & 0 \\ 0 & 1\end{matrix} ]$ | Normalized coefficient, with 1/3 full power PA per port, |
| | with 1/3 full power PA per port: $\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ]$ | with 1/2 full power PA per port: $\frac{1}{\sqrt{3}} [ \begin{matrix}1 & 0 \\ 1 & 0 \\ 0 & 1\end{matrix} ] , \frac{1}{\sqrt{3}} [ \begin{matrix}1 & 0 \\ - 1 & 0 \\ 0 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ - j & 0 \\ 0 & 1\end{matrix} ]$ |
| | With 1/2 full power PA per port: | . . . |
| | $\frac{1}{\sqrt{2}} [ \begin{matrix}1 & 0 \\ 0 & 1 \\ 0 & 0\end{matrix} ] , \frac{1}{\sqrt{2}} [ \begin{matrix}1 & 0 \\ 0 & 0 \\ 0 & 1\end{matrix} ] , \frac{1}{\sqrt{2}} [ \begin{matrix}0 & 0 \\ 1 & 0 \\ 0 & 1\end{matrix} ]$ | For second case, another coherent ports index may be adopted, e.g., case 2-2: $\frac{1}{\sqrt{3}} [ \begin{matrix}0 & 1 \\ 1 & 0 \\ 1 & 0\end{matrix} ] , \frac{1}{\sqrt{3}} [ \begin{matrix}0 & 1 \\ 1 & 0 \\ - 1 & 0\end{matrix} ] , \frac{1}{\sqrt{3}} [ \begin{matrix}0 & 1 \\ 1 & 0 \\ j & 0\end{matrix} ] , \frac{1}{\sqrt{3}} [ \begin{matrix}0 & 1 \\ 1 & 0 \\ - j & 0\end{matrix} ]$ |
| | | For third case, another coherent ports |
| | | index may be adopted, e.g., case 2-2: |
| | | $\frac{1}{\sqrt{3}} [ \begin{matrix}1 & 0 \\ 0 & 1 \\ 1 & 0\end{matrix} ] , \frac{1}{\sqrt{3}} [ \begin{matrix}1 & 0 \\ 0 & 1 \\ - 1 & 0\end{matrix} ] , \frac{1}{\sqrt{3}} [ \begin{matrix}1 & 0 \\ 0 & 1 \\ j & 0\end{matrix} ] , \frac{1}{\sqrt{3}} [ \begin{matrix}1 & 0 \\ 0 & 1 \\ - j & 0\end{matrix} ]$ |
| | | Note: the coherent ports indexing may |
| | | be different from the first case, here |
| | | taking normalized coefficient as |
| | | example. |
| Rank 3 | Normalized coefficient, | For first case, e.g., case 2-1: |
| | with 1/3 full power PA per port, | |
| | with 1/2 full power PA per port: $\frac{1}{\sqrt{3}} [ \begin{matrix}1 & 0 & 0 \\ 0 & 1 & 0 \\ 0 & 0 & 1\end{matrix} ]$ | Normalized coefficient: $\frac{1}{\sqrt{5}} [ \begin{matrix}1 & 1 & 0 \\ 1 & - 1 & 0 \\ 0 & 0 & 1\end{matrix} ] , \frac{1}{\sqrt{5}} [ \begin{matrix}1 & 1 & 0 \\ j & - j & 0 \\ 0 & 0 & 1\end{matrix} ]$ |
| | | with 1/3 full power PA per port, |
| | | with 1/2 full power PA per port: |
| | | $\frac{1}{\sqrt{6}} [ \begin{matrix}1 & 1 & 0 \\ 1 & - 1 & 0 \\ 0 & 0 & 1\end{matrix} ] , \frac{1}{\sqrt{6}} [ \begin{matrix}1 & 1 & 0 \\ j & - j & 0 \\ 0 & 0 & 1\end{matrix} ]$ |
| | | with same coefficient for elements of |
| | | different ports, or |
| | | $[ \begin{matrix}\frac{1}{\sqrt{6}} & \frac{1}{\sqrt{6}} & 0 \\ \frac{1}{\sqrt{6}} & − \frac{1}{\sqrt{6}} & 0 \\ 0 & 0 & \frac{1}{\sqrt{3}}\end{matrix} ] , [ \begin{matrix}\frac{1}{\sqrt{6}} & \frac{1}{\sqrt{6}} & 0 \\ j \frac{1}{\sqrt{6}} & − j \frac{1}{\sqrt{6}} & 0 \\ 0 & 0 & \frac{1}{\sqrt{3}}\end{matrix} ]$ |
| | | with different coefficients for elements |
| | | of different ports |
| | | . . . |
| | | For second case, another coherent ports |
| | | index may be adopted, e.g., case 2-2: |
| | | $\frac{1}{\sqrt{5}} [ \begin{matrix}1 & 0 & 0 \\ 0 & 1 & 1 \\ 0 & 1 & - 1\end{matrix} ] , \frac{1}{\sqrt{5}} [ \begin{matrix}1 & 0 & 0 \\ 0 & 1 & 1 \\ 0 & j & - j\end{matrix} ]$ |
| | | For third case, another coherent ports |
| | | index may be adopted, e.g., case 2-2: |
| | | $\frac{1}{\sqrt{5}} [ \begin{matrix}1 & 0 & 1 \\ 0 & 1 & 0 \\ 1 & 0 & - 1\end{matrix} ] , \frac{1}{\sqrt{5}} [ \begin{matrix}1 & 0 & 1 \\ 0 & 1 & 0 \\ j & 0 & - j\end{matrix} ]$ |
| | | Note: the coherent ports indexing may |
| | | be different from the first case, here |
| | | taking normalized coefficient as |
| | | example. |

A codebook for a three-port uplink transmission via full coherent ports can be determined according to Table 2 below.

TABLE 2

| | Full-coherent |
|---|---|
| Rank 1 | $\frac{1}{\sqrt{3}} [ \begin{matrix}1 \\ 1 \\ 1\end{matrix} ] , \frac{1}{\sqrt{3}} [ \begin{matrix}1 \\ {e}^{j \frac{2 π}{3}} \\ {e}^{j \frac{4 π}{3}}\end{matrix} ] , \frac{1}{\sqrt{3}} [ \begin{matrix}1 \\ {e}^{j \frac{4 π}{3}} \\ {e}^{j \frac{2 π}{3}}\end{matrix} ]$ |
| Rank 2 | $\frac{1}{\sqrt{6}} [ \begin{matrix}1 & 1 \\ 1 & {e}^{j \frac{2 π}{3}} \\ 1 & {e}^{j \frac{4 π}{3}}\end{matrix} ] , \frac{1}{\sqrt{6}} [ \begin{matrix}1 & 1 \\ 1 & {e}^{j \frac{4 π}{3}} \\ 1 & {e}^{j \frac{2 π}{3}}\end{matrix} ] , \frac{1}{\sqrt{6}} [ \begin{matrix}1 & 1 \\ {e}^{j \frac{2 π}{3}} & {e}^{j \frac{4 π}{3}} \\ {e}^{j \frac{4 π}{3}} & {e}^{j \frac{2 π}{3}}\end{matrix} ]$ |
| Rank 3 | $\frac{1}{3} [ \begin{matrix}1 & 1 & 1 \\ 1 & {e}^{j \frac{2 π}{3}} & {e}^{j \frac{4 π}{3}} \\ 1 & {e}^{j \frac{4 π}{3}} & {e}^{j \frac{2 π}{3}}\end{matrix} ]$ |

In some embodiments, for a partially coherent port configuration, which one of the three cases may be selected based on a predefined method. For example, only the first port and the second port are a pair of coherent ports, as shown in the first case in Table 1. In some embodiments, for a partial coherent port configuration, which one of the three cases in a codebook is selected may be determined based on an indication from the network, e.g., subject to the UE capability. In some embodiments, a UE can report which case is supported, e.g., only the first case or only the second case is supported. In some embodiments, the indication from the network may be communicated wo the UE via, e.g., RRC signaling, or DCI signaling.

The UE may report the coherency capability information, e.g., via a coherency information report as part of the capability information, to the network (e.g., to the network device). The coherency information report can include or indicate at least one of the following information: that no ports are coherent, that a first port and a second port are coherent, that a second port and a third port are coherent, that a first port and a third port are coherent, or that all of the three ports are coherent.

### Embodiment 2: Full Power, Power Scaling for Three Ports

A network device (e.g., eNodeB in LTE or gNodeB in 5G) may determine the full transmit power for a PUSCH transmission based on a combination of network-configured parameters, UE capability information, and channel conditions. The UE has a predefined maximum transmit power level, which can be denoted as Pmax. Pmax may be determined by the UE's hardware capability and regulatory constraints. The network device may send power control commands to the UE. These commands may be determined based on the network's assessment of channel quality and interference conditions. The channel assessment may be performed based on an SRS transmission from the UE configured based on an SRS configuration determined by the network device. The UE may measure the path loss, which is the reduction in power density of the radio wave as it propagates through space. It then adjusts its transmit power to compensate for this loss, ensuring that the signal arriving at the base station is at an appropriate power level. The network may configure certain parameters for uplink power control including, e.g., a nominal power level, a path loss compensation factor (e.g., between 0 and 1), measured path loss, a closed-loop power control adjustment (e.g., adjustments based on the Transmit Power Control (TPC) commands from the network device), or the like, or a combination thereof. The transmit power (or full power Pcmax) for PUSCH may be determined based on one or more of these parameters and measurements. The UE may continuously adjust its transmit power in response to changing network commands and channel conditions to maintain optimal performance.

A configured transmit power may be evenly split among three ports in a three-port uplink transmission. Accordingly, the power scaling can be one third for three NZP ports involved in the three-port uplink transmission.

Regarding the full power transmission capability, in some embodiments, all ports can support the full power Pcmax separately, e.g., full power mode 0 is supported.

If one port cannot support the full power Pcmax, each port can be assumed to support one third full power, e.g., full power mode 1 is supported. One or more matrices for the full coherent port configuration can be extended for a precoder selection for full power mode 1 UE.

If full power mode 2 is supported by a UE, one or more TPMIs which can support the full power Pcmax may be reported to the network.

Alternatively, the UE may report, as part of capability information, to the network, information (e.g., referred to as full power transmission capability information) about whether a port or port group can support the full power Pcmax. For example, one or more of the following ports or port combinations can be reported to indicate its capability to support the full power Pcmax: port 0, port 1, port 2, port 0 and port 1, port 0 and port 2, or port 1 and port 2.

A power scaling factor may be determined according to a sum of the numbers (or counts) of ports for SRS resources corresponding to (or to support) a PUSCH transmission. For example, two SRS resources are indicated for one PUSCH transmission, in which one SRS resource is configured with two ports, and the other SRS resource is configured with one port, then two ports+one port=three ports is involved in determining the power scaling factor for the PUSCH transmission. A UE scales the linear transmit power value for a PUSCH transmission by the ratio (i.e., the power scaling factor) of the number (or count) of antenna ports with a non-zero PUSCH transmission power to the sum of numbers (or counts) of ports for all SRS resource(s) collectively corresponding to a PUSCH transmission. An example is provided as follows:

For a PUSCH transmission on active uplink bandwidth part (UL BWP) b, of carrier f of serving cell c, a UE first calculates a linear value \hat{P}_{PUSCH,b,f,c}(i, j, q_{d}, l) of the transmit power P_{PUSCH,b,f,c}(i, j, q_{d}, l), with parameters as defined in clause 7.1.1 as in TS38.213. For a PUSCH transmission scheduled by a DCI format other than DCI format 0_0, or configured by ConfiguredGrantConfig or semiPersistentOnPUSCH, if txConfig in PUSCH-Config is set to ‘codebook’,
if ul-FullPower Transmission in PUSCH-Config is provided, the UE scales \hat{P}_{PUSCH,b,f,c}(i, j, qa, l) by s where:
if ul-FullPower Transmission in PUSCH-Config is set to fullpowerMode1, s is the ratio of a number of antenna ports with non-zero PUSCH transmission power over the sum of numbers of ports for each SRS resource corresponding to a PUSCH transmission.
if ul-FullPowerTransmission in PUSCH-Config is set to fullpowerMode2,
s=1 for full power TPMIs reported by the UE, and s is the ratio of a number of antenna ports with non-zero PUSCH transmission power over a number of SRS ports for remaining TPMIs, where the number of SRS ports is associated with one or more SRS resources indicated by one or more SRI fields in a DCI format scheduling the PUSCH transmission, or indicated by Type 1 configured grant, or the number of SRS ports is associated with the SRS resources if only two SRS resources are configured in the SRS-ResourceSet with usage set to ‘codebook’, e.g., for 3-port PUSCH transmission,
s=1, if an SRS resource with a single port is indicated by an SRI field in a DCI format scheduling the PUSCH transmission when more than one SRS resource is provided in the SRS-Resource Set with usage set to ‘codebook’, or indicated by Type 1 configured grant, or if only one SRS resource with a single port is provided in the SRS-ResourceSet with usage set to ‘codebook’, and
if ul-FullPower Transmission in PUSCH-Config is set to fullpower, s=1
else, if each SRS resource in the SRS-ResourceSet with usage set to ‘codebook’ has more than one SRS port, the UE scales the linear value by the ratio of the number of antenna ports with a non-zero PUSCH transmission power to the sum of the numbers (or counts) of ports for all SRS resource(s) collectively corresponding to or supporting a PUSCH transmission.

The UE may split the full power Pcmax equally across the antenna ports on which the UE transmits the PUSCH with non-zero power.

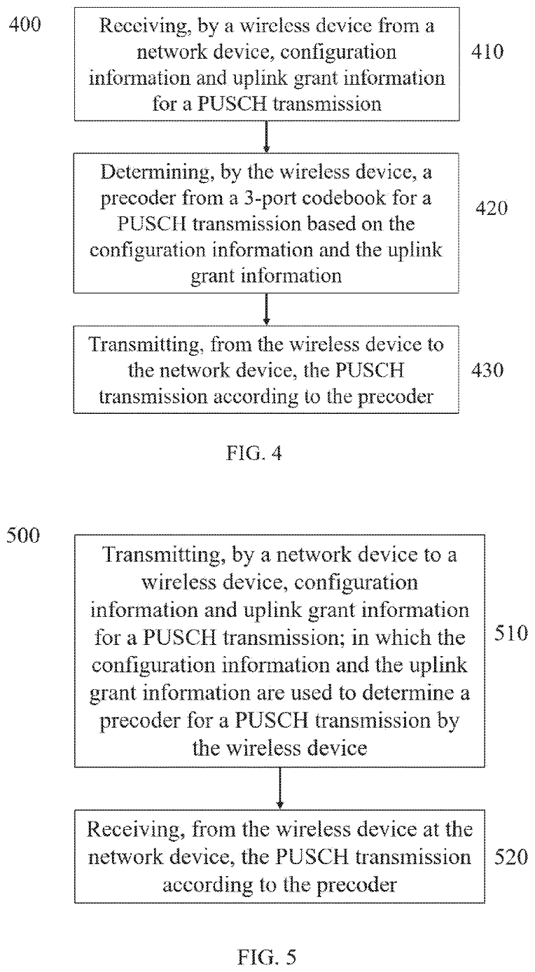

Some embodiments may implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station. The following listing of solutions may be implemented by some preferred embodiments.
1. A method of wireless communication (e.g., method 400 as illustrated in FIG. 4), including: receiving 410, by a wireless device from a network device, configuration information and uplink grant information for a PUSCH transmission, in which the configuration information indicates a codebook to be used with the three-port uplink transmission; determining 420, by the wireless device, a precoder from a 3-port codebook for a PUSCH transmission based on the configuration information and the uplink grant information; and transmitting 430, from the wireless device to the network device, the PUSCH transmission according to the precoder.
2. A method of wireless communication (e.g., method 500 as illustrated in FIG. 5), including: transmitting 510, by a network device to a wireless device, configuration information and uplink grant information for a PUSCH transmission; in which the configuration information and the uplink grant information are used to determine a precoder for a PUSCH transmission by the wireless device; and receiving 520, at the network device from the wireless device, the PUSCH transmission according to the precoder.
3. The method of any one or more of the solutions disclosed herein, in which the configuration information is determined based on or relates to capability information of the wireless device. The wireless device may report the capability information to the network device.
4. The method of any one or more of the solutions disclosed herein, in which the capability information includes coherency capability information and full power transmission capability information.
5. The method of any one or more of the solutions disclosed herein, in which the coherency capability information includes: that none of three ports for the three-port uplink transmission are coherent, that the three ports are partially coherent in which only two of the three ports are coherent, or that the three ports are fully coherent. For example, the coherency information may include that none of three ports for a three-port uplink transmission are coherent, that the three ports are fully coherent, that the three ports are partially coherent in which only two of the three ports are coherent, that the three ports are partially coherent in which only a first and a second ports of the three ports are coherent, that the three ports are partially coherent in which only the second and a third ports of the three ports are coherent, that the three ports are partially coherent in which only the first and the third ports are coherent, that the three ports are partially coherent in which only the first one of the three ports is not coherent with the other ports, that the three ports are partially coherent in which only the second port of the three ports is not coherent with the other ports, or that the three ports are partially coherent in which only the third port of the three ports is not coherent with the other ports.
6. The method of any one or more of the solutions disclosed herein, in which the codebook includes one or more of: (i) information based on the coherency capability information, (ii) information based on the full power transmission capability information, or (iii) rank information for a transmission rank for the three-port uplink transmission.
7. The method of any one or more of the solutions disclosed herein, in which: the three ports include a first port having a first configuration, a second port having a second configuration, and a third port having a third configuration, and the coherency capability information includes which two of the three ports are coherent.
8. The method of any one or more of the solutions disclosed herein, in which the full power transmission capability information includes power amplifier (PA) information of the respective three ports indicating whether the wireless device not supporting full power transmission with a single one of the three ports.
9. The method of any one or more of the solutions disclosed herein, in which: the PA information of the respective three ports indicates that each of the three ports is configured to support up to one third of a full power output of the three-port uplink transmission, and the codebook includes a coefficient determined based on the number of ports which is three and a maximum number of layers of the three-port uplink transmission according to the rank information.
10. The method of any one or more of the solutions disclosed herein, in which: the PA information of the respective three ports indicates that at least one of the three ports is configured to support up to a half of a full transmission power of the three-port uplink transmission, and the codebook includes a coefficient determined based on one of (1) a product of the number of ports which is three and a maximum number of layers of the three-port uplink transmission according to the rank information, and (2) the maximum number of layers of the three-port uplink transmission.
11. The method of any one or more of the solutions disclosed herein, in which the codebook reflects power information relating to splitting a full transmission power of the three-port uplink transmission. In some embodiments, a power scaling factor may be directly used for power scaling of transmit power of the PUSCH transmission.
12. The method of any one or more of the solutions disclosed herein, in which the power scaling factor is determined based on a sum of the number(s) (or count(s)) of non-zero power ports of the three ports to support the three-port uplink transmission.
13. The method of any one or more of the solutions disclosed herein, in which the capability information of the wireless device includes one or more transmit precoding matrix indicators (TPMIs) that are partial coherent TPMIs for rank 2 and/or rank 3 using the three ports.
14. The method of any one or more of the solutions disclosed herein, in which the capability information of the wireless device includes information on at least one specific TPMI which delivers a full transmission power of the three-port uplink transmission.
15. The method of any one or more of the solutions disclosed herein, in which the at least one specific TPMI which delivers the full transmission power is based on a non-coherent TPMI and/or a partial coherent TPMI.
16. The method of any one or more of the solutions disclosed herein, in which the configuration information includes DCI that includes information for a TPMI for the three-port uplink transmission.
17. The method of any one or more of the solutions disclosed herein, in which the 3-port codebook is determined according to candidate codebook types, and the configuration information includes a codebook type for the PUSCH transmission.
18. The method of any one or more of the solutions disclosed herein, in which the codebook type includes at least one of: that none of three ports for a three-port uplink transmission are coherent, that the three ports are fully coherent, that the three ports are partially coherent in which only two of the three ports are coherent, that the three ports are partially coherent in which only a first and a second ports of the three ports are coherent, that the three ports are partially coherent in which only the second and a third ports of the three ports are coherent, that the three ports are partially coherent in which only the first and the third ports are coherent, that the three ports are partially coherent in which only the first one of the three ports is not coherent with the other ports, that the three ports are partially coherent in which only the second port of the three ports is not coherent with the other ports, or that the three ports are partially coherent in which only the third port of the three ports is not coherent with the other ports.
19. The method of any one or more of the solutions disclosed herein, in which the codebook type is reported by the wireless device to the network device as a wireless device capability.
20. The method of any one or more of the solutions disclosed herein, in which the uplink grant information for the PUSCH transmission includes at least one of: a sounding reference source (SRS) resource indicator (SRI), a number of layers, or a transmit precoding matrix indicator (TPMI).
21. The method of any one or more of the solutions disclosed herein, in which the number of layers and the TPMI in the uplink grant information for the PUSCH transmission are used to determine, from the 3-port codebook, the precoder for the PUSCH transmission.
22. The method of any one or more of the solutions disclosed herein, in which: for a candidate codebook type being noncoherent, the 3-port codebook is determined by one vector from a set of vectors of for a one-layer codebook, two vectors from the set of vectors for a two-layer codebook, or three vectors from the set of vectors for a three-layer codebook, the set of vectors including:

$$[ \begin{matrix}1 \\ 0 \\ 0\end{matrix} ] , [ \begin{matrix}0 \\ 1 \\ 0\end{matrix} ] , or [ \begin{matrix}0 \\ 0 \\ 1\end{matrix} ] .$$

23. The method of any one or more of the solutions disclosed herein, in which: for a candidate codebook type being partial coherent, the 3-port codebook is determined according to at least one of:

$$[ \begin{matrix}1 \\ 1\end{matrix} ] , [ \begin{matrix}1 \\ - 1\end{matrix} ] , [ \begin{matrix}1 \\ j\end{matrix} ] , or [ \begin{matrix}1 \\ - j\end{matrix} ]$$

for a pair of ports and element of 0 for a single port to form a 3 by 1 matrix for a one-layer codebook;

$$[ \begin{matrix}1 \\ 1\end{matrix} ] , [ \begin{matrix}1 \\ - 1\end{matrix} ] , [ \begin{matrix}1 \\ j\end{matrix} ] , or [ \begin{matrix}1 \\ - j\end{matrix} ]$$

for the pair of ports and element of 0 for a single port for one layer, and element of 1 for the single port with elements of 0s for the pair of ports for the other layer, to form a 3 by 2 matrix for a two-layer codebook; or

$$[ \begin{matrix}1 & 1 \\ 1 & - 1\end{matrix} ] , or [ \begin{matrix}1 & 1 \\ j & - j\end{matrix} ]$$

for the pair of ports and [0, 0] for the non coherent port the two layers, and element of 1 for the single port with elements of 0s for the two coherent ports for the other layer, to form a 3 by 3 matrix for a three-layer codebook.
24. The method of any one or more of the solutions disclosed herein, in which ports of the pair of ports are coherent, and the single port is not coherent with any one port of the pair of ports.
25. The method of any one or more of the solutions disclosed herein, in which the single port corresponds to one of a first, a second, or a third port in the 3-port codebook, and the ports of the pair of ports correspond to the remaining 2 ports in the 3-port codebook.
26. The method of any one or more of the solutions disclosed herein, in which a mapping between the single port or the pair of ports and the three ports in the 3-port codebook is determined according to a predefined relation, the configuration information, or wireless device capability.
27. The method of any one or more of the solutions disclosed herein, in which: the coefficient of a precoding matrix or of an element in the precoding matrix for the precoder is determined according to one of:

$$\frac{1}{\sqrt{M}} ,$$

where M is a number of non-zero power (NZP) elements in the precoding matrix;

$$\frac{1}{\sqrt{{N}_{port} * {N}_{p}}}$$

for port p; or

$$\frac{1}{\sqrt{{N}_{port} * {max}_{p} {N}_{p}}}$$

for each port, where Nₚ is the number of NZP elements for port p, and Nₚₒᵣₜ is the number of ports in the precoding matrix.
28. The method of any one or more of the solutions disclosed herein, in which: in response to a number of NZP ports being less than 3, Nₚₒᵣₜ is 2, or in response to (1) power amplifier (PA) information of NZP port being ½ full power or ½ maximum transmit power and (2) a number of NZP ports being less than 3, Nₚₒᵣₜ is 2.
29. The method of any one or more of the solutions disclosed herein, in which: for a candidate codebook type being full-coherent, the codebook is determined by:

$$\frac{1}{\sqrt{3}} [ \begin{matrix}1 \\ 1 \\ 1\end{matrix} ] , \frac{1}{\sqrt{3}} [ \begin{matrix}1 \\ {e}^{j \frac{2 π}{3}} \\ {e}^{j \frac{4 π}{3}}\end{matrix} ] , and / or \frac{1}{\sqrt{3}} [ \begin{matrix}1 \\ {e}^{j \frac{4 π}{3}} \\ {e}^{j \frac{2 π}{3}}\end{matrix} ]$$

for a one-layer codebook,

$$\frac{1}{\sqrt{6}} [ \begin{matrix}1 & 1 \\ 1 & {e}^{j \frac{2 π}{3}} \\ 1 & {e}^{j \frac{4 π}{3}}\end{matrix} ] , \frac{1}{\sqrt{6}} [ \begin{matrix}1 & 1 \\ 1 & {e}^{j \frac{4 π}{3}} \\ 1 & {e}^{j \frac{2 π}{3}}\end{matrix} ] , and / or \frac{1}{\sqrt{6}} [ \begin{matrix}1 & 1 \\ {e}^{j \frac{2 π}{3}} & {e}^{j \frac{4 π}{3}} \\ {e}^{j \frac{4 π}{3}} & {e}^{j \frac{2 π}{3}}\end{matrix} ]$$

for a two-layer codebook, or

$$\frac{1}{3} [ \begin{matrix}1 & 1 & 1 \\ 1 & {e}^{j \frac{2 π}{3}} & {e}^{j \frac{4 π}{3}} \\ 1 & {e}^{j \frac{4 π}{3}} & {e}^{j \frac{2 π}{3}}\end{matrix} ]$$

for a three-layer codebook.
30. The method of any one or more of the solutions disclosed herein, further including: determining, by the wireless device, a power scaling factor for the PUSCH transmission according to a number of ports corresponding to the PUSCH transmission; and transmitting, from the wireless device to the network device, the PUSCH transmission according to the precoder and the power scaling factor.
31. The method of any one or more of the solutions disclosed herein, in which the number of ports corresponding to the PUSCH transmission is determined by one of: a sum of numbers of ports configured for a plurality of SRS resources corresponding to the PUSCH transmission; a number of ports configured for an SRS resource corresponding to the PUSCH transmission; or a number of ports used for transmitting an SRS resource corresponding to the PUSCH transmission.
32. A wireless communication device, including: at least one processor configured to perform the method recited in any one or more of solutions 1-31.
33. One or more non-transitory computer-readable media storing computer-executable instructions that, when executed by one or more processors, cause the one or more processors to perform any one of the method recited in any one or more of solutions 1-31.

It will be appreciated that the present document discloses techniques that can be embodied in various embodiments to allow a UE-triggered reporting of beam report information. Specifically, events for beam reporting are defined based on measurement quality variation monitoring among beams at different time instances/beam groups or for different channels/RSs. The beam reporting would be triggered if any of the pre-defined events occurs. As the event-triggered beam report is initiated by the UE on demand, the reporting latency and uplink reporting resource consumption can be greatly reduced compared with the conventional beam report method.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of the present application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device from a network device, configuration information and uplink grant information for a physical uplink shared channel (PUSCH) transmission;
determining, by the wireless device, a precoder from a 3-port codebook for a PUSCH transmission based on the configuration information and the uplink grant information,
wherein the 3-port codebook is determined according to a candidate codebook type, and the configuration information includes a codebook type for the PUSCH transmission, and
wherein for the candidate codebook type being non-coherent, the 3-port codebook is determined by one vector from a set of vectors of for a one-layer codebook, two vectors from the set of vectors for a two-layer codebook, or three vectors from the set of vectors for a three-layer codebook, the set of vectors comprising:
$$[ \begin{matrix}1 \\ 0 \\ 0\end{matrix} ] , [ \begin{matrix}0 \\ 1 \\ 0\end{matrix} ] , or [ \begin{matrix}0 \\ 0 \\ 1\end{matrix} ] ;$$
and
transmitting, from the wireless device to the network device, the PUSCH transmission according to the precoder.

2. The method of claim 1, wherein the codebook type comprises that none of three ports for a three-port uplink transmission are coherent.

3. The method of claim 1, wherein the uplink grant information for the PUSCH transmission comprises at least one of: a sounding reference source (SRS) resource indicator (SRI), a number of layers, or a transmit precoding matrix indicator (TPMI).

4. The method of claim 3, wherein the number of layers and the TPMI in the uplink grant information for the PUSCH transmission are used to determine, from the 3-port codebook, the precoder for the PUSCH transmission.

5. The method of claim 1, wherein:
for a candidate codebook type being partial-coherent, the 3-port codebook is determined according to at least one of:
$$[ \begin{matrix}1 \\ 1\end{matrix} ] , [ \begin{matrix}1 \\ - 1\end{matrix} ] , [ \begin{matrix}1 \\ j\end{matrix} ] , or [ \begin{matrix}1 \\ - j\end{matrix} ]$$
for a pair of ports and element of 0 for a single port to form a 3-by-1 matrix for a one-layer codebook;
$$[ \begin{matrix}1 \\ 1\end{matrix} ] , [ \begin{matrix}1 \\ - 1\end{matrix} ] , [ \begin{matrix}1 \\ j\end{matrix} ] , or [ \begin{matrix}1 \\ - j\end{matrix} ]$$
for the pair of ports and element of 0 for a single port for one layer, and element of 1 for the single port with elements of 0s for the pair of ports for the other layer, to form a 3-by-2 matrix for a two-layer codebook; or
$$[ \begin{matrix}1 & 1 \\ 1 & - 1\end{matrix} ] , or [ \begin{matrix}1 & 1 \\ j & - j\end{matrix} ]$$
for the pair of ports and [0, 0] for the non coherent port the two layers, and element of 1 for the single port with elements of 0s for the two coherent ports for the other layer, to form a 3-by-3 matrix for a three-layer codebook.

6. The method of claim 1, wherein:
a coefficient of a precoding matrix or of an element in the precoding matrix for the precoder is determined according to one of:
$$\frac{1}{\sqrt{M}} ,$$
where M is a number of non-zero power (NZP) elements in the precoding matrix;
$$\frac{1}{\sqrt{{N}_{port} * {N}_{p}}}$$
for port p; or
$$\frac{1}{\sqrt{{N}_{port} * {max}_{p} {N}_{p}}}$$
for each port, where Nₚ is the number of NZP elements for port p, and Nₚₒᵣₜ is the number of ports in the precoding matrix.

7. The method of claim 1, wherein:
for a candidate codebook type being full-coherent, the codebook is determined by:
$$\frac{1}{\sqrt{3}} [ \begin{matrix}1 \\ 1 \\ 1\end{matrix} ] , \frac{1}{\sqrt{3}} [ \begin{matrix}1 \\ {e}^{j \frac{2 π}{3}} \\ {e}^{j \frac{4 π}{3}}\end{matrix} ] , and / or \frac{1}{\sqrt{3}} [ \begin{matrix}1 \\ {e}^{j \frac{4 π}{3}} \\ {e}^{j \frac{2 π}{3}}\end{matrix} ]$$
for a one-layer codebook,
$$\frac{1}{\sqrt{6}} [ \begin{matrix}1 & 1 \\ 1 & {e}^{j \frac{2 π}{3}} \\ 1 & {e}^{j \frac{4 π}{3}}\end{matrix} ] , \frac{1}{\sqrt{6}} [ \begin{matrix}1 & 1 \\ 1 & {e}^{j \frac{4 π}{3}} \\ 1 & {e}^{j \frac{2 π}{3}}\end{matrix} ] , and / or \frac{1}{\sqrt{6}} [ \begin{matrix}1 & 1 \\ {e}^{j \frac{2 π}{3}} & {e}^{j \frac{4 π}{3}} \\ {e}^{j \frac{4 π}{3}} & {e}^{j \frac{2 π}{3}}\end{matrix} ]$$
for a two-layer codebook, or
$$\frac{1}{3} [ \begin{matrix}1 & 1 & 1 \\ 1 & {e}^{j \frac{2 π}{3}} & {e}^{j \frac{4 π}{3}} \\ 1 & {e}^{j \frac{4 π}{3}} & {e}^{j \frac{2 π}{3}}\end{matrix} ]$$
for a three-layer codebook.

8. The method of claim 1, further comprising:
determining, by the wireless device, a power scaling factor for the PUSCH transmission according to a number of ports corresponding to the PUSCH transmission.

9. The method of claim 8, wherein the number of ports corresponding to the PUSCH transmission is determined by:
a number of ports used for transmitting an SRS resource corresponding to the PUSCH transmission.

10. The method of claim 9, wherein an SRI in the uplink grant information for the PUSCH transmission indicates the SRS resource corresponding to the PUSCH transmission.

11. The method of claim 1, wherein:
for a candidate codebook type being non-coherent, the 3-port codebook is determined by:
$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ]$$
for rank 1;
$$\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ]$$
for rank 2; and
$$\frac{1}{\sqrt{3}} [ \begin{matrix}1 & 0 & 0 \\ 0 & 1 & 0 \\ 0 & 0 & 1\end{matrix} ]$$
for rank 3.

12. A wireless communication device, comprising:
at least one processor configured to:
receive, from a network device, configuration information and uplink grant information for a physical uplink shared channel (PUSCH) transmission;
determine a precoder from a 3-port codebook for a PUSCH transmission based on the configuration information and the uplink grant information,
wherein the 3-port codebook is determined according to a candidate codebook type, and the configuration information includes a codebook type for the PUSCH transmission, and
wherein for the candidate codebook type being non-coherent, the 3-port codebook is determined by one vector from a set of vectors of for a one-layer codebook, two vectors from the set of vectors for a two-layer codebook, or three vectors from the set of vectors for a three-layer codebook, the set of vectors comprising:
$$[ \begin{matrix}1 \\ 0 \\ 0\end{matrix} ] , [ \begin{matrix}0 \\ 1 \\ 0\end{matrix} ] , or [ \begin{matrix}0 \\ 0 \\ 1\end{matrix} ] ;$$
and
transmit, to the network device, the PUSCH transmission according to the precoder.

13. A method of wireless communication, comprising:
transmitting, by a network device to a wireless device, configuration information and uplink grant information for a physical uplink shared channel (PUSCH) transmission, wherein the configuration information and the uplink grant information are used to determine a precoder for a PUSCH transmission by the wireless device,
wherein the 3-port codebook is determined according to a candidate codebook type, and the configuration information includes a codebook type for the PUSCH transmission, and
wherein for the candidate codebook type being non-coherent, the 3-port codebook is determined by one vector from a set of vectors of for a one-layer codebook, two vectors from the set of vectors for a two-layer codebook, or three vectors from the set of vectors for a three-layer codebook, the set of vectors comprising:
$$[ \begin{matrix}1 \\ 0 \\ 0\end{matrix} ] , [ \begin{matrix}0 \\ 1 \\ 0\end{matrix} ] , or [ \begin{matrix}0 \\ 0 \\ 1\end{matrix} ] ;$$
and
receiving, from the wireless device to the network device, the PUSCH transmission according to the precoder.

14. The method of claim 13, wherein:
for a candidate codebook type being non-coherent, the 3-port codebook is determined by:
$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ]$$
for rank 1;
$$\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ]$$
for rank 2; and
$$\frac{1}{\sqrt{3}} [ \begin{matrix}1 & 0 & 0 \\ 0 & 1 & 0 \\ 0 & 0 & 1\end{matrix} ]$$
for rank 3.

15. The method of claim 13, wherein the codebook type comprises that none of three ports for a three-port uplink transmission are coherent.

16. The method of claim 13, wherein the uplink grant information for the PUSCH transmission comprises at least one of: a sounding reference source (SRS) resource indicator (SRI), a number of layers, or a transmit precoding matrix indicator (TPMI).

17. The method of claim 16, wherein the number of layers and the TPMI in the uplink grant information for the PUSCH transmission are used to determine, from the 3-port codebook, the precoder for the PUSCH transmission.

18. The method of claim 13, further comprising:
determining, by the wireless device, a power scaling factor for the PUSCH transmission according to a number of ports corresponding to the PUSCH transmission.

19. The method of claim 18, wherein the number of ports corresponding to the PUSCH transmission is determined by:
a number of ports used for transmitting an SRS resource corresponding to the PUSCH transmission.

20. The method of claim 19, wherein an SRI in the uplink grant information for the PUSCH transmission indicates the SRS resource corresponding to the PUSCH transmission.
